(19) United States
(12) Patent Application Publication
(10) Pub. No.: US 2016/0362995 A1
(43) Pub. Date: Dec. 15, 2016

(54) ROTOR FOR A TURBOMACHINE AND COMPRESSOR

(71) Applicant: MTU Aero Engines AG, Muenchen (DE)

(72) Inventor: Lothar Albers, Muenchen (DE)

(21) Appl. No.: 15/148,567

(22) Filed: May 6, 2016

(30) Foreign Application Priority Data
May 7, 2015 (EP) EP15166680.7

(51) Int. Cl. F01D 11/00; F04D 29/54; F04D 29/08; F04D 29/32; F01D 5/02; F01D 9/04

(52) U.S. Cl. CPC F01D 11/001; F01D 5/02; F01D 9/041; F04D 29/083; F04D 29/321; F04D 29/542; F05D 2220/32

(57) ABSTRACT

A rotor for a turbomachine having at least a first rotor main body and a second rotor main body, the second rotor main body having a rotor arm having an arrangement for form-fittingly flange-mounting the first rotor main body to the second rotor main body, the arrangement having a balancing ring disposed on the radially outer side of the rotor arm is provided. The balancing ring is integrally connected to the rotor arm for form-fittingly flange-mounting the second rotor main body to the first rotor main body, the arrangement being disposed at the upstream and/or downstream end of the rotor arm. A compressor of a turbomachine having a rotor is also provided.

This claims the benefit of European Patent Application EP 15166680.7, filed May 7, 2015 and hereby incorporated by reference herein.

The present invention relates to a rotor for a turbomachine. The present invention also relates to a compressor.

### BACKGROUND

Rotors for turbomachines must satisfy a variety of requirements and boundary conditions. For example, it should be possible to balance individual rotor stages to allow them to operate with little wear and low maintenance at high rotational speeds. Moreover, rotors should be optimized in terms of space requirements and have a low weight in order to satisfy economic boundary conditions such as, for example, low kerosene consumption. Finally, possible oil accumulations in cavities in the inner rotor space, such as accumulations of bearing oil, should be allowed to flow off so as to prevent possible contamination of cabin air streams by discharges from the compressor.

### SUMMARY OF THE INVENTION

It is an object of the present invention to provide a rotor for a turbomachine that has at least one rotor arm having a balancing ring. Another alternate or additional object of the present invention is to provide a compressor having a rotor according to the present invention.

The present invention provides a rotor for a turbomachine, the rotor having at least a first rotor main body and a second rotor main body. The second rotor main body has a rotor arm having an arrangement for form-fittingly flange-mounting the first rotor main body to the second rotor main body, in particular by means of a press fit. The form-fitting flange-mounting arrangement has at least one balancing ring on the radially outer side of the rotor arm. The balancing ring may be referred to as a balancing collar. The balancing ring of the inventive rotor is integrally connected to the rotor arm for form-fittingly flange-mounting the second rotor main body to the first rotor main body.

The balancing ring integrally connected to the rotor arm may be a balancing ring that is frictionally connected to the rotor arm by an interference fit. In particular, a balancing ring integrally connected to the rotor arm is not a balancing ring that could easily be mechanically detached by means of a threaded connection and/or a non-interference form-fit connection. A balancing ring integrally connected to the rotor arm by means of an interference fit may advantageously be balanced using a material-removal process, such as milling, drilling or grinding, without having to partially or completely remove the balancing ring from the rotor.

The arrangement for form-fittingly flange-mounting the second rotor main body to the first rotor main body is disposed at the upstream and/or downstream end(s) of the rotor arm. Thus, the arrangement includes at least one portion of the rotor arm located at its upstream and/or downstream end(s) and the balancing ring integrally connected to this portion of the rotor arm.

The balancing ring is disposed on the radially outer side of the rotor, in particular on the radially outer side of a rotor drum of the rotor. The radially outer side of the rotor may be referred to as outer rotor space. In particular, the balancing ring is not disposed in the inner rotor space; i.e., inside the rotor drum.

Specific exemplary embodiments of the present invention may include one or more of the features mentioned below.

In the following, in particular, gas turbines will be described merely as an example of turbomachines, but without limiting turbomachines to gas turbines. The turbomachine may, in particular, be an axial turbomachine. The gas turbine may, in particular, be an axial gas turbine such as, for example, an aircraft gas turbine.

The term “rotor,” as used herein, refers to a rotating body in a turbomachine, which rotates about an axis of rotation of the turbomachine during normal operational use. The rotor includes at least one rotor stage. A rotor stage may be referred to as a blade wheel or include a blade wheel. A rotor stage includes at least a plurality of rotor blades and a rotor main body. The rotor main body may be referred to as, or include, a disk, rotor disk, ring, or rotor ring. A rotor may have one or more rotor stages.

A rotor may be mounted and installed in a turbomachine, in particular in a gas turbine. An aircraft engine may be a gas turbine or include a gas turbine. An aircraft engine may include a compressor having a plurality of compressor stages and a turbine having a plurality of turbine stages. Compressor stages and turbine stages may each have rotor stages and stator stages.

The rotor blades of a rotor may be referred to as blades and each have at least an airfoil portion, a root portion and a platform portion. The blades may be connected to the rotor main body either integrally therewith or separately, for example, form-fittingly by means of releasable connections known as dovetail connections. Separate blades may be connected to the rotor main body either releasably and/or form-fittingly and/or by a material-to-material bond. An integral connection is, in particular, a material-to-material bond. An integral connection may be produced using an additive manufacturing process. A rotor main body having blades integrally connected therewith may be referred to as integrally bladed rotor. An integrally bladed rotor may be what is known as a BLISK (bladed disk) or a BLING (bladed ring).

The rotor main body may include radially inwardly directed rotor disks and/or axially oriented rotor arms. The radially inwardly directed rotor disks may be referred to as extensions or T-shaped extensions of the rotor blades.

The rotor arms may be referred to as drum members. The rotor is designed or prepared for direct or indirect connection to a shaft of the turbomachine. An indirect connection may be via a hub and/or via further rotors. In the case of a direct connection, the rotor may be flange-mounted directly to the shaft.

The term “rotor drum,” as used herein, refers to sections of at least two axially interconnected rotor main bodies. In particular, rotor arms may form a rotor drum. A rotor drum may also be configured to extend over more than two rotor main bodies, and optionally over a plurality of rotor arms and rotor disks. For example, a plurality of rotor main bodies of an eight-stage compressor in a turbomachine may form one rotor drum.

The terms “inner rotor space” and “outer rotor space,” as used herein, refer to the spaces inside and outside of the rotor drum of rotors. Thus, the inner rotor space is radially outwardly bounded essentially by one or more rotor arms. The inner rotor space is axially bounded essentially by rotor disks. Generally, a gap is formed between a shaft to which the rotor drum is directly or indirectly connected and the rotor disks. The outer rotor space is radially inwardly bounded essentially by one or more rotor arms. The outer rotor space substantially includes the main flow passage of the turbomachine. Furthermore, between a rotor arm and the main flow passage, there may be disposed, for example, inner stator rings, either with or without abradable seals. The inner rotor space and/or the outer rotor space may include a plurality of rotor stages.

Rotor main bodies arranged axially one behind the other may be interconnected by rotor arms and/or rotor disks. The connection is, in particular, by form-fitting engagement and/or frictional engagement.

Annular balancing collars may be disposed inside the rotor drum, in particular on the inner side of the rotor arms. The balancing collars may be connected to the rotor arms by frictional engagement. Alternatively or additionally, further balancing devices, such as flanges having balancing weights mounted circumferentially therearound, may be disposed inside the rotor drum.

In certain embodiments according to the present invention, the rotor main bodies; i.e., the first and the second rotor main bodies, are prepared for receiving rotor blades to form a first rotor stage including the first rotor main body and a second rotor stage including the second rotor main body.

In certain embodiments according to the present invention, the rotor main bodies are integrally connected to rotor blades. A blade wheel having a rotor main body and a plurality of integrally connected rotor blades arranged on the periphery may be referred to as “blisk.” The term “blisk” is composed of the separate terms blade and disk (blisk: blade integrated disk). A “blisk” is a rotor design where the disk and the blade may be manufactured from one piece.

In several embodiments of the present invention, the rotor main bodies are form-fittingly, in particular releasably, connected to the rotor blades. A form-fitting releasable connection may be what is known as a dovetail connection.

In some embodiments of the present invention, the rotor arm has at least one sealing tip for reducing leakage flows between the rotor and static components of the turbomachine, in particular the stator vane assembly. The stator vane assembly may be referred to as a stator stage.

In several embodiments of the present invention, the sealing tips are configured to form a sealing gap with respect to an abradable seal. The abradable seal may be disposed on a radially inner end portion of an inner ring of a stator vane assembly. In particular, a stator vane assembly has variable stator vanes which, on the one hand, may be adjustably mounted in the casing of the turbomachine and, on the other hand, rotatably mounted in the inner ring by means of inner trunnions.

In certain embodiments according to the present invention, the radial extent of the balancing ring is less than the radial extent of the sealing tips. In other words, the outer diameter of the balancing ring is less than the outer diameter of the sealing tips. The outer diameter of the sealing tips may be approximately equal to the inner diameter of the abradable seal (in the case of a plurality of abradable seals, the inner diameter refers to the smallest inner diameter of the abradable seals). This may advantageously facilitate the mounting and removal of the blade wheel and the stator vane assembly (including the inner ring) in the turbomachine.

In certain embodiments of the present invention, the rotor arm is made from or contains a first material. The balancing ring may be made from or contain a second material. The first material and the second material are different. This advantageously makes it possible, for example, to simplify shrink-fitting of the balancing ring onto rotor arm and/or removal of material from the balancing ring for balancing purposes.

In some embodiments of the present invention, the balancing ring has on its periphery at least one region for material removal for balancing of the rotor.

In several embodiments of the present invention, the first rotor main body has a balancing flange having at least one balancing weight. In particular, the balancing flange has a non-continuous contour around its circumference (as viewed in the main flow direction). A continuous contour would be, for example, a closed, annular contour. The non-continuous contour of the balancing flange prevents the formation of a cavity in which liquid could accumulate on an axial side of the balancing flange. Thus, no liquid can form due to centrifugal force during rotation of the rotor main body. It is nevertheless possible to fix balancing weights on the balancing flange in a distributed manner around the circumference thereof.

In certain embodiments according to the present invention, the rotor arm has an opening allowing fluids to pass therethrough from the inner rotor space to the outer rotor space. For example, bearing oil, in particular condensed bearing oil mist, can be spun off from a hub located in the immediate vicinity of the rotor stage through the opening and into the main flow passage during rotation of the rotor according to the present invention.

The inventive compressor of a turbomachine has at least one rotor according to the present invention and at least one stator stage having an inner ring. The compressor may be a high-pressure compressor of an aircraft engine.

Some or all of the embodiments of the present invention may have one, several or all of the advantages mentioned above and/or hereinafter.

The rotor according to the present invention advantageously makes it possible to prevent, or at least reduce, oil accumulations, for example, accumulations of bearing oil, in the inner rotor space; i.e., inside the rotor drum. In particular, by disposing the balancing flange on the radially outer side of the rotor, it is achieved that only small cavities, or no cavities at all, in which oil may accumulate (called wake regions) may be formed in the rotor drum. In an application of the rotor in an aircraft engine, this at least reduces the possibility of cabin air being contaminated by bearing oil.

The rotor according to the present invention may be used in turbines and/or compressors. By positioning the balancing ring in an axial end region of the rotor arm, it is possible to advantageously optimize the space requirements and weight of the rotor, and thus of the turbomachine. Thus, economic advantages may be obtained, for example, by reduced kerosene consumption and/or a compact design.

The placement of the balancing ring outside of the rotor drum, and thus at a larger diameter as compared to placement of the balancing ring inside of the rotor drum, may lead to a reduction in mass and weight of the flange arrangement (arrangement for form-fittingly flange-mounting another rotor main body). This may advantageously lead to a reduction in weight of the rotor stage.

### BRIEF DESCRIPTION OF THE DRAWINGS

The present invention will now be described, by way of example only, with reference to the accompanying drawings, in which identical or similar components are indicated by the same reference numerals. The figures are simplified schematic views in which:

FIG. 1 shows, in cross-sectional view, an inventive rotor having a balancing ring, a second rotor main body flange-mounted to a first rotor main body, as well as a stator vane assembly;

FIG. 2 shows a detail of FIG. 1, illustrating the distance between the inner ring of the stator vane assembly and the first rotor main body, as well as between the balancing ring of the second rotor main body and the inner ring;

FIG. 3 shows a detail from FIG. 1, illustrating another balancing ring geometry;

FIG. 4 shows a detail from FIG. 1, illustrating yet another balancing ring geometry;

FIG. 5 shows a detail from FIG. 1, illustrating different flow conditions around the balancing ring;

FIG. 6 shows different balancing planes at a rotor stage;

FIG. 7 shows a perspective view of a portion of a rotor main body with a balancing ring; and

FIG. 8 shows the perspective view of FIG. 7, illustrating an example of a balanced balancing ring.

### DETAILED DESCRIPTION

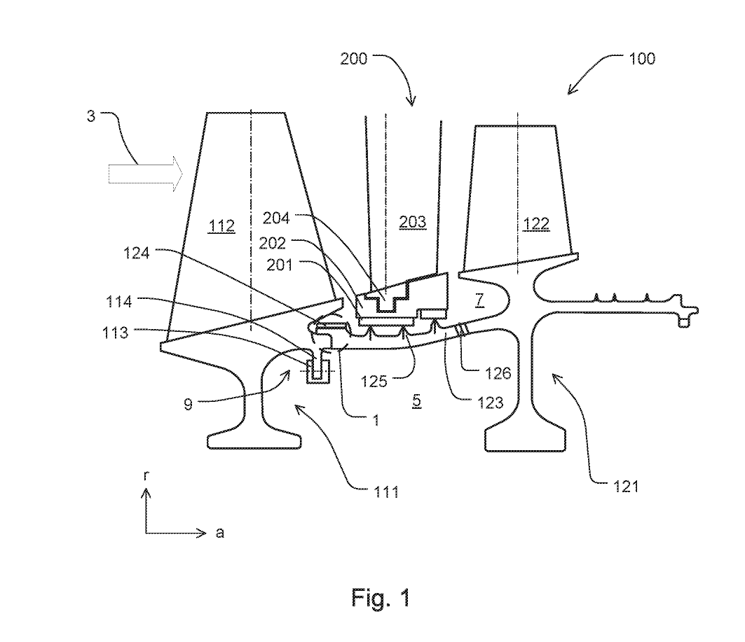

FIG. 1 shows, in cross-sectional view, an inventive rotor 100 having a balancing ring 124, a second rotor main body 121 flange-mounted to a first rotor main body 111, as well as a stator vane assembly 200.

Second rotor main body 121 includes a rotor arm 123 having an arrangement 1 for form-fittingly flange-mounting second rotor main body 121 to first rotor main body 111. Arrangement 1 includes a balancing ring 124 integrally connected to rotor arm 123 at the axially forward (upstream) end of rotor arm 123. Axial direction a is oriented in main flow direction 3 of the turbomachine. Balancing ring 124 integrally connected to rotor arm 123 is frictionally connected to rotor arm 123 by an interference fit. Rotor blades 112, 122 are integrally connected to rotor main bodies 111, 121.

In FIG. 1, rotor arm 123 further has sealing tips 125 which form a gap with abradable seals 201 to minimize leakage flow between rotor 100 and a stator vane assembly 200. Abradable seals 201 are connected to an inner ring 202, which in turn is connected to the radial inner ends of stator vanes 203. Stator vanes 203 are rotatably and adjustably supported in inner ring 202 via inner trunnions 204.

Rotor arm 123 further has a radial hole 126, through which, for example, quantities of oil (e.g., bearing oil) which have accumulated in inner rotor space 5 may flow off to outer rotor space 7 into the main flow area. Radial hole 126 may be referred to as oil spin-off hole. Such oil accumulations may form, in particular, in cavities 9 in the region of balancing flanges 114 (having separate balancing weights 113 screwed thereto). Since balancing ring 124 is disposed on the radially outer side of rotor arm 123 (and not on the radially inner side of rotor arm 123) of rotor 100 according to the present invention, oil accumulations may partially or completely flow off through radial hole 126 into outer rotor space 7 due to centrifugal force during rotation of rotor 100, provided that balancing flange 114 is not configured as a circumferentially closed ring. By disposing balancing ring 124 of inventive rotor 100 in outer rotor space 7, it is advantageously possible to completely, or at least substantially, prevent oil from accumulating in cavities 9.

First rotor main body 111 is connected by arrangement 1 to second rotor main body 121 by means of an annular form-fitting and releasable connection. Balancing ring 124 integrally connected to rotor arm 123 does not have any structural-mechanical effect on the form-fitting connection of arrangement 1. One structural-mechanical effect could be, for example, deformation of arrangement 1 due to an interference fit that is structurally embodied differently than in FIG. 1 and produces stress states in the material.

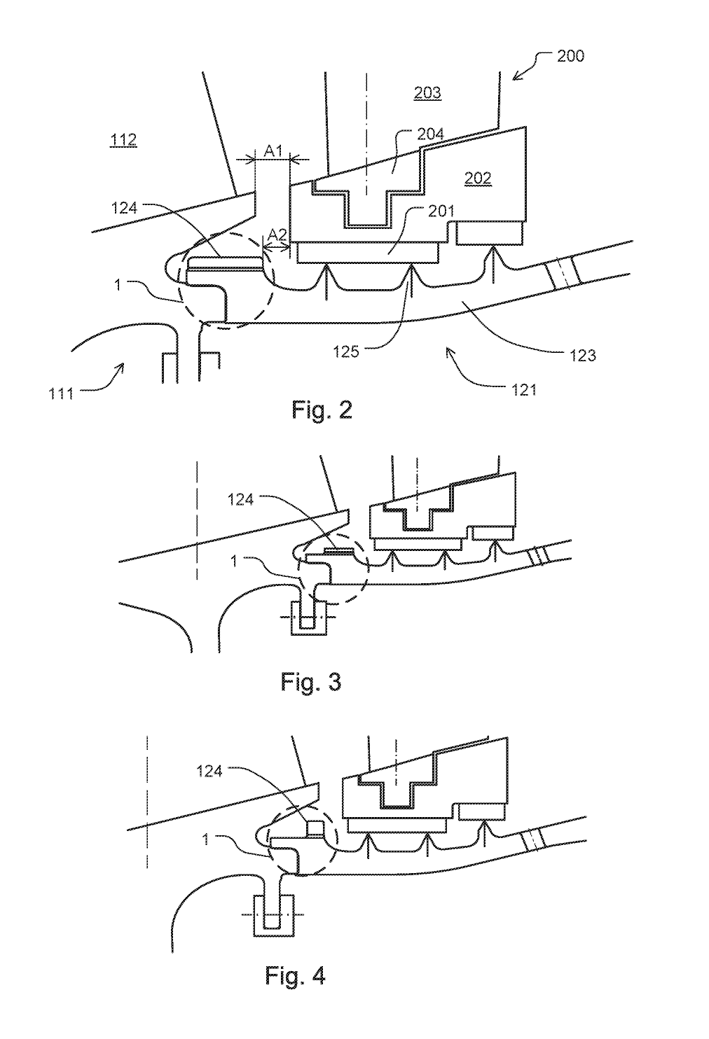

FIG. 2 shows a detail of FIG. 1, illustrating a distance A1 between inner ring 202 of stator vane assembly 200 and first rotor main body 111, as well as a distance A2 between balancing ring 124 and inner ring 202.

Distance A1 between inner ring 202 of stator vane assembly 200 and first rotor main body 111 generally has a minimum value determined by structural and operational requirements in order to prevent contact between the two components. Furthermore, distance A2 between a balancing ring 124 and inner ring 202 generally has a value at least equal to that of distance A1 in order to prevent contact between these components. Since balancing ring 124 in the present embodiment is configured integrally with rotor arm 123 in the region of arrangement 1, the inventive rotor 100 makes it possible to reduce the axial space required by the blade wheel and stator vane assembly in the region of balancing ring 124. A reduction in space requirements may, for example, advantageously reduce the weight of the turbomachine.

FIG. 3 shows a detail from FIG. 1, illustrating another balancing ring geometry. Balancing ring 124 has a smaller axial extent or dimension than in FIG. 1 and FIG. 2. The particular dimensioning and structural design of balancing ring 124 may be adapted in accordance with, for example, the type of turbomachine and possible operating conditions.

FIG. 4 shows a detail from FIG. 1, illustrating yet another balancing ring geometry. Balancing ring 124 is axially shorter and radially larger than balancing ring 124 of FIG. 3. The cross-sectional shape of balancing ring 124 is approximately square.

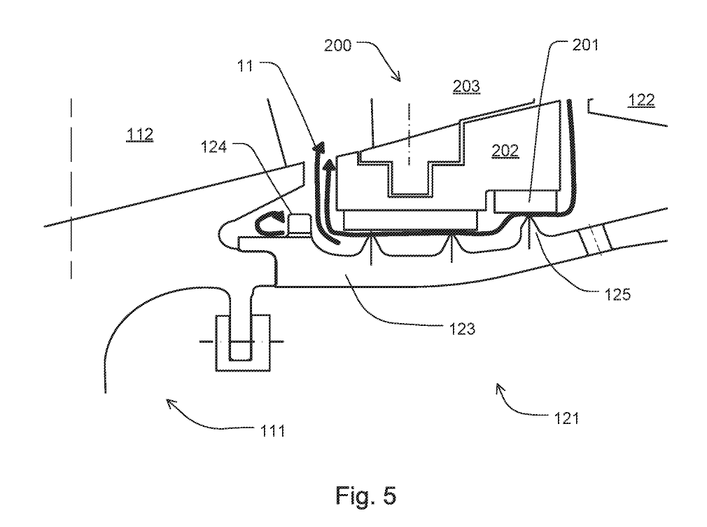

FIG. 5 shows a detail from FIG. 1, illustrating different flow conditions around balancing ring 124. The flow around inner ring 202 (leakage flow 11 between sealing tips 125 and abradable seal 201), called cavity flow, occurs with essentially no disturbance. It is only between balancing ring 124 and first rotor main body 111 that a small vortex can be seen outside of leakage flow 11.

Small turbulences (called windage) generally result in a low friction loss. Higher friction losses can result in thermodynamic losses and higher air temperatures in the rotor cavities. When leakage flow 11 reenters the gas duct (main flow passage), the higher air temperatures can result in aerodynamic losses and a decrease in the efficiency of the turbomachine, for example, the efficiency of the compressor.

Thus, using the inventive rotor 100, the illustrated flow conditions around balancing ring 124 may lead to less or negligible disturbance of leakage flow 11.

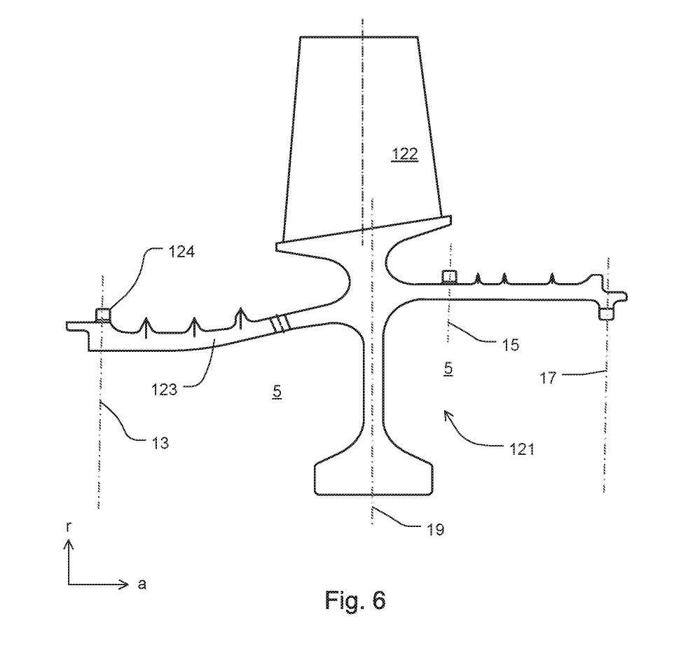

FIG. 6 shows different balancing planes 13, 15, 17 at rotor main body 121. However, only balancing plane 13 represents a balancing plane of a rotor 100 according to the present invention. Balancing planes 15 and 17 are merely shown for the purpose of the explanations below.

The position and arrangement of balancing planes 13, 15, 17 is considered with respect to a center-of-gravity plane 19 of the blade wheel (rotor main body 121, rotor arm 123, rotor blades 122). Basically, blades wheels (or individual rotor stages) can be balanced statically and dynamically. If the blade wheel is to be balanced dynamically, then the distance between balancing plane 13, 15, 17 and center-of-gravity plane 19 is a relevant parameter. For dynamic balancing, it is advantageous that balancing plane 13, 15, 17 be axially as far as possible from center-of-gravity plane 19 so that the balancing mass of balancing ring 124 can be designed to be small and save weight.

Among the illustrated balancing planes 13, 15, 17, in particular balancing plane 13 of second rotor main body 121 is advantageous because it is far away from center-of-gravity plane 19. In contrast, balancing plane 17 (here, the balancing ring is disposed in inner rotor space 5) is closer to center-of-gravity plane 19. In particular, the balancing ring of balancing plane 15 is located in an inconvenient position because it is close to center-of-gravity plane 19. Therefore, this balancing ring of balancing plane 15 would have to be larger and heavier than the balancing rings of balancing planes 13 and 17.

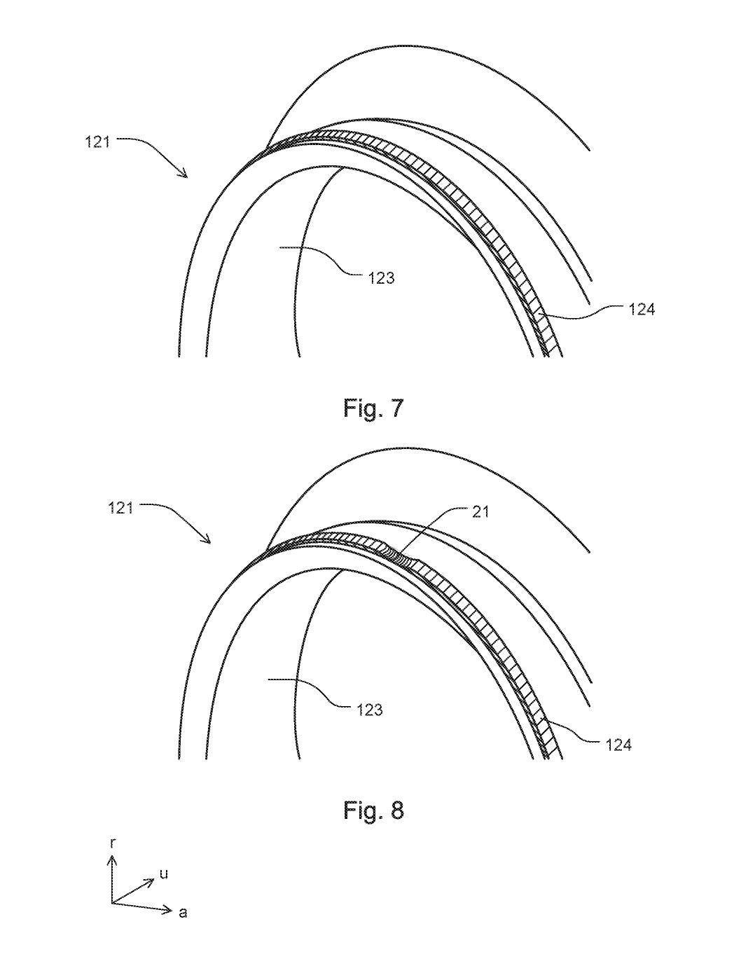

FIG. 7 shows, in perspective view, a portion of an inventive rotor 100 having a balancing ring 124. For the purpose of illustration, balancing ring 124 is shown in hatched lines on rotor arm 123. For the sake of simplification, the sealing tips are not shown in FIG. 7 and FIG. 8.

FIG. 8 shows the perspective view of FIG. 7, illustrating an example of a balanced balancing ring 124. A trough-shaped material-removal region 21 of balancing ring 124 has been created, for example, by machining, such as by milling or drilling. The balancing may be accomplished in particular using a static or dynamic method.

### LIST OF REFERENCE NUMERALS

a axial; axial direction
r radial; radial direction
u circumferential direction
A1 distance between the inner ring of the stator vane assembly and the first rotor main body
A2 distance between the inner ring of the stator vane assembly and the balancing ring
100 rotor
111 first rotor main body
112 rotor blade
113 balancing weight
114 balancing flange
121 second rotor main body
122 rotor blade
123 rotor arm
124 balancing ring
125 sealing tip
126 radial hole in the rotor arm
200 stator vane assembly
201 abradable seal
202 inner ring
203 stator vane
204 inner trunnion
1 arrangement for form-fittingly flange-mounting another rotor
3 main flow direction
5 inner rotor space; inside the rotor drum
7 outer rotor space; radially outer side of the rotor
9 cavity
11 leakage flow
13 balancing plane
15 balancing plane
17 balancing plane
19 center-of-gravity plane
21 material-removal region of the balancing ring

What is claimed is:

1. A rotor for a turbomachine, the rotor comprising:
at least a first rotor main body; and
a second rotor main body, the second rotor main body having a rotor arm having an arrangement for form-fittingly flange-mounting the first rotor main body to the second rotor main body, the arrangement including a balancing ring disposed on a radially outer side of the rotor arm, the balancing ring being integrally connected to the rotor arm for form-fittingly flange-mounting the second rotor main body to the first rotor main body, the arrangement being disposed at an upstream or downstream end of the rotor arm.

2. The rotor as recited in claim 1 wherein the first and second rotor main bodies receive rotor blades to form a first rotor stage and a second rotor stage.

3. The rotor as recited in claim 1 wherein the first and second rotor main bodies are integrally connected to rotor blades.

4. The rotor as recited in claim 1 wherein the rotor arm has at least one sealing tip for reducing leakage flows between the rotor and a stator vane assembly of the turbomachine.

5. The rotor as recited in claim 4 wherein the at least one sealing tip is configured to form a sealing gap with respect to an abradable seal.

6. The rotor as recited in claim 1 wherein a radial extent of the balancing ring is less than a radial extent of at least one sealing tip on the rotor arm.

7. The rotor as recited in claim 1 wherein the rotor arm is made from or contains a first material, and the balancing ring is made from or contains a second material, the first material and the second material being different.

8. The rotor as recited in claim 1 wherein the balancing ring has on a periphery at least one region for material removal for balancing of the rotor.

9. The rotor as recited in claim 1 wherein the first rotor main body has a balancing flange having at least one balancing weight.

10. The rotor as recited in claim 1 wherein the rotor arm has an opening allowing fluids to pass therethrough from an inner rotor space to an outer rotor space.

11. A compressor of a turbomachine, the compressor comprising:
at least one rotor as recited in claim 1; and
at least one stator stage having an inner ring.

12. A high-pressure compressor of an aircraft engine comprising the compressor as recited in claim 11.
